(19) United States
(12) Patent Application Publication
(10) Pub. No.: US 2017/0032558 A1
(43) Pub. Date: Feb. 2, 2017

(54) MULTI-FORMAT CALENDAR DIGITIZATION

(71) Applicant: Zipcal LLC, South Lebanon, OH (US)

(72) Inventors: Peter Charles Mason, JR., South Lebanon, OH (US); Peter Charles Mason, South Lebanon, OH (US); David Paul Miller, Harrison, OH (US); Robert Feltner, Dayton, OH (US); Michael J. Sliper, Beavercreek, OH (US)

(21) Appl. No.: 15/222,750

(22) Filed: Jul. 28, 2016

Related U.S. Application Data
(60) Provisional application No. 62/198,463, filed on Jul. 29, 2015.

(51) Int. Cl. G06T 11/60; G06T 7/00

(52) U.S. Cl. CPC G06T 11/60; G06T 7/0081; G06T 2210/22; G06T 2207/10004

(57) ABSTRACT

Technologies for digitizing a physical version of a calendar include a mobile computing device. The mobile computing device receives a source image representative of a physical version of a calendar. The source image is cropped to an identified textual region of interest to generate a cropped source image. The mobile computing device analyzes the cropped source image to identify time management data included therein. A calendar event is generated based at least in part on the identified time management data. The mobile computing device stores the generated calendar event in a local calendar database. Other embodiments are described and claimed.

### CROSS REFERENCE TO RELATED APPLICATION

This application claims the benefit of U.S. Provisional Patent Application Ser. No. 62/198,463, filed on Jul. 29, 2015, entitled MULTI-FORMAT CALENDAR DIGITIZATION, the disclosure of which is hereby incorporated by reference in its entirety.

### TECHNICAL FIELD

Embodiments of the technologies described herein relate, in general, to the field of schedule management. More particularly, the technologies described herein relate to the field of digitizing calendars of multiple formats.

### SUMMARY

In an embodiment, the present disclosure is directed, in part, to a method for digitizing a physical version of a calendar. The method includes receiving, by a mobile computing device, a source image representative of a physical version of a calendar. The method further includes identifying, by the mobile computing device, a textual region of interest within the source image and cropping, by the mobile computing device, the source image to the textual region of interest to generate a cropped source image. In addition, the method includes analyzing, by the mobile computing device, the cropped source image to identify time management data included therein. The method further includes generating, by the mobile computing device, a calendar event based at least in part on the identified time management data. The method also includes storing, by the mobile computing device, the generated calendar event in a local calendar database of the mobile computing device.

In a further embodiment, the present disclosure is directed, in part, to another method for digitizing a physical version of a calendar. The method includes receiving, by a mobile computing device, a source image representative of a physical version of a calendar and cropping, by the mobile computing device, the source image to generate a paper image. The paper image includes only a region of the source image within which the physical version of the calendar is represented. The method further includes generating, by the mobile computing device, a cropped text image based on the paper image. The cropped text image includes only a region of the paper image within which character objects are presented. The method additionally includes removing, by the mobile computing device, non-textual objects presented within the cropped text image to generate a cropped non-graphical text image and generating, by the mobile computing device, an enhanced binary image based on the cropped non-graphical text image. The enhanced binary image is an image including pixels of only two colors. The method also includes generating, by the mobile computing device, a plurality of horizontal sub-images based on lines of text located within the enhanced binary image. Each horizontal sub-image of the plurality of horizontal sub-images corresponds to a different line of text located within the enhanced binary image. In addition, the method includes locating, by the mobile computing device, one or more text phrases within each of the plurality of horizontal sub-images and generating, by the mobile computing device, a plurality of bounding boxes relative to the paper image. Each of the generated bounding boxes corresponds to a different one of the one or more text phrases located within the plurality of horizontal sub-images. The method further includes determining, by the mobile computing device, semantic information for each text phrase located within the plurality of horizontal sub-images and generating, by the mobile computing device, a candidate calendar event based at least in part on the determined semantic information for each text phrase located within the plurality of horizontal sub-images. The method also includes displaying, by the mobile computing device, the candidate calendar event for user approval and storing, by the mobile computing device, the candidate calendar event in a local calendar database of the mobile computing device in response to receiving user approval data.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a system for digitizing calendars of multiple formats;

FIG. 2 is a simplified flow diagram of at least one embodiment of a method that may be executed by the mobile computing device of FIG. 1 for digitizing calendars of multiple formats; and

FIGS. 3 and 4 are a simplified flow diagram of at least one other embodiment of a method that may be executed by the mobile computing device of FIG. 1 for digitizing calendars of multiple formats.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

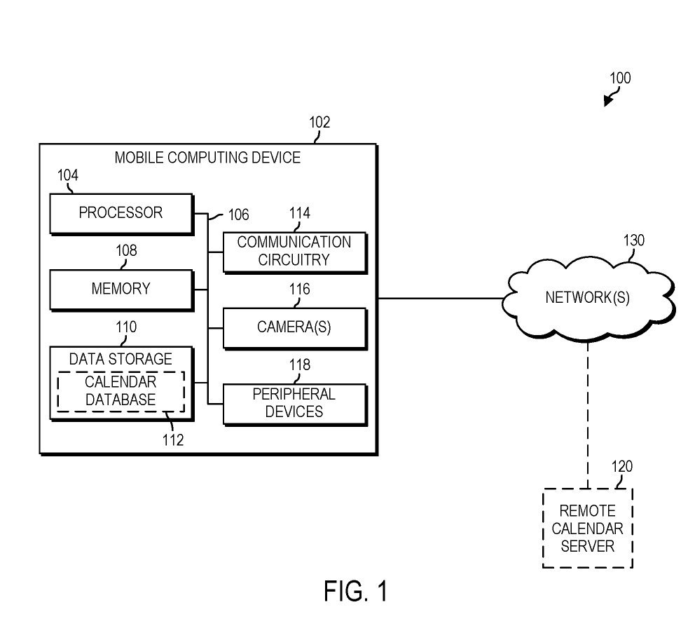

Referring now to FIG. 1, in one embodiment, a system 100 for digitizing calendars of multiple formats includes a mobile computing device 102. In some embodiments, the mobile computing device 102 is communicatively coupled to a remote calendar server 120 via one or more networks 130. In operation, the mobile computing device 102 is configured to capture an image of a paper or physical version of a calendar, agenda, schedule, or any other type of time management data. The captured image can be analyzed by the mobile computing device 102. In some embodiments, the mobile computing device 102 can perform optical character recognition (OCR) on the image to recognize text phrases. Based on the recognized text phrases, the mobile computing device 102 can be used to generate one or more candidate calendar events. In some embodiments, the mobile computing device 102 generates multiple calendar events based on the text phrases recognized in the captured image. In such embodiments, the multiple calendar events are saved to a calendar database 112 of the mobile computing device 102.

In some embodiments, the mobile computing device 102 can analyze the image of the paper or physical version of the calendar, agenda, schedule, or any other type of time management data based on one or more templates. In such embodiments, each template can correspond to a particular type of calendar, agenda, and/or schedule and can define the optical character recognition settings or strategy for recognizing or formatting text for that particular type of calendar, agenda, and/or schedule. For example, the mobile computing device 102 can analyze a team schedule based on a schedule template that defines optimal processing settings for schedules.

As discussed, the mobile computing device 102 can analyze the image of the paper or physical version of other type of time management data. For example, in some embodiments, the mobile computing device 102 can analyze an image of a prescription label. In such embodiments, the mobile computing device 102 can generate one or more reoccurring events based on content recognized from the prescription label. For instance, based on the dispensed quantity and prescription directions, the mobile computing device 102 can generate a reoccurring event to remind a user to take their medication at a certain time (e.g., day, time of day, etc.). The reoccurring event may be configured by the mobile computing device 102 to last a finite amount of time calculated based at least in part on, or otherwise as a function of, the dispensed quantity and prescription directions. Additionally, in some embodiments, the mobile computing device 102 can analyze an image of an appointment card (e.g., a doctor's appointment, a dental appointment, a hair appointment, etc.), In such embodiments, the mobile computing device 102 can generate a calendar event that corresponds to the appointment data captured from the appointment card. Of course, it should be appreciated that the mobile computing device 102 can analyze images of paper or physical versions of calendars, agendas, schedules, or any other type of time management data that include event information in a format other than typed text. For example, in some embodiments, the mobile computing device 102 can analyze calendars, agendas, or schedules that include handwritten event information. In such embodiments, the mobile computing device 102 can perform OCR on the calendars, agendas, or schedules and recognize handwritten text phrases.

Additionally, in some embodiments, the mobile computing device 102 can determine or predict missing or omitted date values (e.g., months, days of the week, years, etc.) from the paper or physical version of the calendar, agenda, or schedule. For example, the mobile computing device 102 can replace a missing or omitted date value with the most recently recognized date value, such as in daily schedules which list multiple events on a single date. In another embodiment, the mobile computing device 102 can determine to increment a date value based on a recognized date value sequence. For example, if the recognized month for successive events regresses or restarts (e.g., December to January, etc.), the mobile computing device 102 can increment the year. In another example, if a recognized event includes the day of the week, a month, and a day of the month (e.g., Friday, March 3), the mobile computing device 102 can determine the year (or years) in which that particular day of the month falls on that particular day of the week. It should be appreciated that the mobile computing device 102 can determine or predict missing or omitted date values using any other technique or logic.

The mobile computing device 102 can also determine, predict, or imply the duration of an event, travel times associated with an event, alert times for an event, a target calendar for the event, and whether the event occurs in the morning or evening (e.g., AM or PM). For example, in some embodiments, the mobile computing device 102 can maintain a knowledge database that includes the actual values (or default values) selected by a user for the duration of an event, travel times associated with an event, alert times for an event, a target calendar for the event, and whether the event occurs in the morning or evening. Such values can be associated with keywords, which when matched by the mobile computing device 102 during processing, can be used to replace omitted event data. For example, if the name of a particular professional baseball team is recognized during digitization of a paper or physical version of a calendar, agenda, or schedule, the mobile computing device 102 can determine or imply the location (e.g., stadium address, stadium city, etc.) of a particular baseball game, the travel time (e.g., 25 minutes, etc.) to the baseball game, the anticipated duration (e.g., three hours, etc.) of the baseball game, a preferred alert time (e.g., 30 minutes prior to first pitch, etc.) for the baseball game, and the preferred calendar (e.g., a baseball fan's calendar, etc.) that the corresponding event should be saved. It should be appreciated that the mobile computing device 102 can utilize machine learning or other forms of artificial intelligence to “learn” additional user preferences and selections as the user captures and digitizes subsequent calendars.

Additionally or alternatively, the mobile computing device 102 can also determine, predict, or imply the time zone associated with a particular calendar event. For example, in some embodiments, the mobile computing device 102 can associate a default time zone for recognized events. In other examples, the mobile computing device 102 can maintain a list of time zones associated with particular keywords (e.g., sports team name, event title, etc.). During digitization of a calendar, the mobile computing device 102 can associate a particular time zone for an event based on matching one of the corresponding keywords.

In some embodiments, the mobile computing device 102 can also obtain (e.g., collect, request, retrieve, etc.) user-specific information. For example, the mobile computing device 102 can collect information (e.g., profile information, social media posts, product or service reviews, etc.) about the user from one or more remote social media sites or electronic data sources. In such examples, the mobile computing device 102 can compare newly recognized calendar events to the collected user-specific information. Based on the comparison, the mobile computing device 102 can verify the veracity of the newly recognized calendar events.

Additionally, in some embodiments, the mobile computing device 102 can generate one or more alerts (or warnings) and/or share calendar events with multiple users. For example, the mobile computing device 102 can generate a warning in response to determining that the user is double booking a time slot. In another example, the mobile computing device 102 can automatically share newly added calendar events with other users. For instance, in response to recognizing a new calendar event from a paper or physical version of a calendar, agenda, or schedule, the mobile computing device 102 can share or otherwise transmit a copy of the event to another user's calendar.

In some embodiments, the mobile computing device 102 can also enable a user to filter events based on the event data. For example, the mobile computing device 102 can be configured to receive input data indicative of the particular types of events (e.g., home games, team-specific events, weekday-specific morning classes, instructor name, future events, etc.) the user is interested in adding to a calendar. In such cases, the mobile computing device 102 can display only those events that match or satisfy the received input data (e.g., the filter data).

The mobile computing device 102 can be embodied as any type of computing device or server capable of processing, communicating, storing, maintaining, and transferring data. For example, the mobile computing device 102 can be embodied as a smart phone, a tablet computer, a personal digital assistant, a handheld computer, a laptop computer, a telephony device, a desktop computer, a server, a microcomputer, a minicomputer, a mainframe, a custom chip, an embedded processing device, or other computing device and/or suitable programmable device. In some embodiments, the mobile computing device 102 can be embodied as a computing device integrated with other systems or subsystems. In the illustrative embodiment, the mobile computing device 102 includes a processor 104, a system bus 106, a memory 108, a data storage 110, communication circuitry 114, one or more camera(s) 116, and one or more peripheral devices 118. Of course, the mobile computing device 102 can include other or additional components, such as those commonly found in a server and/or computer (e.g., various input/output devices), in other embodiments. Additionally, in some embodiments, one or more of the illustrative components can be incorporated in, or otherwise from a portion of, another component. For example, the memory 108, or portions thereof, can be incorporated in the processor 104 in some embodiments. Furthermore, it should be appreciated that the mobile computing device 102 can include other components, sub-components, and devices commonly found in a computer and/or computing device, which are not illustrated in FIG. 1 for clarity of the description.

The processor 104 can be embodied as any type of processor capable of performing the functions described herein. For example, the processor 104 can be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

In various configurations, the mobile computing device 102 includes a system bus 106 for interconnecting the various components of the mobile computing device 102. The system bus 106 can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 104, the memory 108, and other components of the mobile computing device 102. In some embodiments, the mobile computing device 102 can be integrated into one or more chips such as a programmable logic device or an application specific integrated circuit (ASIC). In such embodiments, the system bus 106 can form a portion of a system-on-a-chip (SoC) and be incorporated, along with the processor 104, the memory 108, and other components of the mobile computing device 102, on a single integrated circuit chip.

The memory 108 can be embodied as any type of volatile or non-volatile memory or data storage capable of performing the functions described herein. For example, the memory 108 can be embodied as read only memory (ROM), random access memory (RAM), cache memory associated with the processor 104, or other memories such as dynamic RAM (DRAM), static RAM (SRAM), programmable ROM (PROM), electrically erasable PROM (EEPROM), flash memory, a removable memory card or disk, a solid state drive, and so forth. In operation, the memory 108 can store various data and software used during operation of the mobile computing device 102 such as operating systems, applications, programs, libraries, and drivers.

The data storage 110 can be embodied as any type of device or devices configured for short-term or long-term storage of data such as, for example, memory devices and circuits, memory cards, hard disk drives, solid-state drives, or other data storage devices. For example, in some embodiments, the data storage 110 includes storage media such as a storage device that can be configured to have multiple modules, such as magnetic disk drives, floppy drives, tape drives, hard drives, optical drives and media, magneto-optical drives and media, compact disc drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 104, or the memory 108 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

In some embodiments, the data storage device 110 can be configured to store a calendar database 112. The calendar database 112 can include event data (e.g., event name, description, date, start time, end time, location, notes, etc.) corresponding to one or more calendar events. These calendar events, in some embodiments, can be segregated into one or more calendars identified by name (e.g., “Home,” “Work,” “Spouse,” “Son,” “Daughter,” etc.) or any other means of identification. For example, work related meetings can be associated with the user's “Work” calendar, while the volleyball practices of a user's daughter can be associated with the user's “Daughter” calendar. In some embodiments, a calendar application (“calendar app”) executed by the mobile computing device 102 can access the calendar database 112 and visually display the one or more calendar events to a user. Additionally or alternatively, the calendar database 112, or the event data stored therein, can be synchronized with the remote calendar server 120, in some embodiments.

The communication circuitry 114 of the mobile computing device 102 can be embodied as any type of communication circuit, device, interface, or collection thereof, capable of enabling communications between the mobile computing device 102 and remote calendar server 120 and/or any other computing device communicatively coupled thereto. For example, the communication circuitry 114 can be embodied as one or more network interface controllers (NICs), in some embodiments. The communication circuitry 114 can be configured to use any one or more communication technologies (e.g., wireless or wired communications) and associated protocols (e.g., Ethernet, WiMAX, etc.) to effect such communication.

In some embodiments, the mobile computing device 102 and the remote calendar server 120 and/or any other computing devices of the system 100, can communicate with each other over one or more networks 130. The network(s) 130 can be embodied as any number of various wired and/or wireless communication networks. For example, the network(s) 130 can be embodied as or otherwise include a local area network (LAN), a wide area network (WAN), a cellular network, or a publicly-accessible, global network such as the Internet. Additionally, the network(s) 130 can include any number of additional devices to facilitate communication between the computing devices of the system 100.

The camera(s) 116 can be embodied as any type of camera and/or optical scanner, such as a digital camera (e.g., a digital point-and-shoot camera, a digital single-lens reflex (DSLR) camera, etc.), a video camera, or the like, that is capable of capturing images and/or video of a paper or physical version of a calendar, agenda, schedule, or any other type of time management data. Additionally, in some embodiments, the mobile computing device 102 can further include one or more peripheral devices 118. Such peripheral devices 118 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

The remote calendar server 120 can be embodied as any type of computing device capable of performing the functions described herein. As such, the remote calendar server 120 can include devices and structures commonly found in computing devices such as processors, memory devices, communication circuitry, and data storages, which are not shown in FIG. 1 for clarity of the description. The remote calendar server 120 can be configured to remotely store event data (e.g., event name, description, start time, end time, location, notes, etc.) corresponding to one or more calendar events. In some embodiments, the remote calendar server 120 receives the event data from the mobile computing device 102. The event data stored by the remote calendar server 120 can be transmitted to other computing devices (not shown) of the system 100 for population into a local calendar. Such other computing devices can include multiple devices of the same user as well as additional devices of other users of a shared event.

In some embodiments, the mobile computing device 102 and the remote calendar server 120 can each establish an environment during operation. Each environment can include various modules, components, sub-components, and devices commonly found in computing devices, which are not illustrated in the figures for clarity of the description. The various modules, components, sub-components, and devices of each environment can be embodied as hardware, firmware, software, or a combination thereof For example, one or more of the modules, components, sub-components, and devices of each environment can be embodied as a processor and/or a controller configured to provide the functionality described herein.

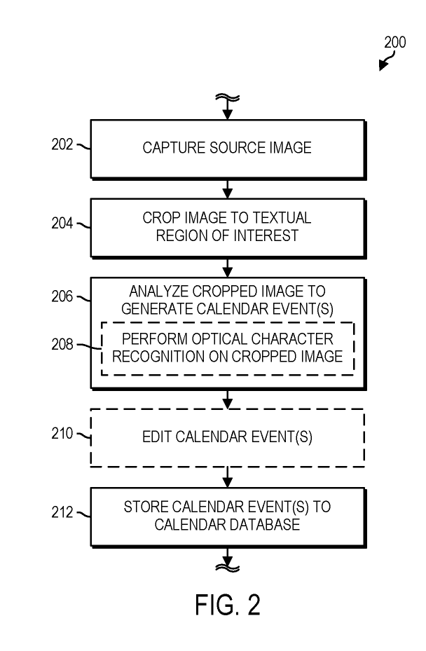

Referring now to FIG. 2, a method 200 that may be executed by the mobile computing device 102 for digitizing calendars begins with block 202 in which the mobile computing device 102 captures a source image of a paper or physical version of a calendar, agenda, schedule, or any other type of time management data. To do so, in some embodiments, the mobile computing device 102 can capture the source image via the one or more cameras 116. Additionally or alternatively, the source image of the paper or physical version of the calendar or agenda can be captured by a device other than the mobile computing device 102 including, but not limited to, digital cameras, video cameras, and optical scanners (e.g., flatbed scanner, all-in-one printer/scanner/copier, etc.). In such embodiments, the mobile computing device 102 can receive the source image from the device that captured the image or an intermediary computing device (e.g., a cloud server, another mobile computing device, etc.). In other embodiments, the mobile computing device 102 can retrieve the source image from a local repository (e.g., the data storage 110) of the mobile computing device 102.

In block 204, the mobile computing device 102 crops the source image to a textual region of interest. In some embodiments, the mobile computing device 102 automatically determines the location and size of the textual region of interest. For example, the mobile computing device 102 can be configured to automatically determine areas within the source image that contain text. In some embodiments, the mobile computing device 102 can be configured to enable a user to select and/or resize an automatically-suggested textual region of interest. Regardless of how the mobile computing device 102 determines or identifies the textual region of interest, the mobile computing device 102 crops the source image to the textual region of interest.

In block 206, the mobile computing device 102 analyzes the cropped image to generate one or more calendar events therefrom. To do so, in block 208, the mobile computing device 102 can perform optical character recognition (OCR) on the cropped image. Alternatively, OCR may be performed by another computing device (e.g., cloud server, etc.) with the results communicated to the mobile computing device 102. It should be appreciated that any number of different OCR techniques, image processing algorithms, and/or artificial intelligence (AI) methods may be performed on the cropped image and derived data to identify calendar events, text phrases, words, or individual characters. The generated calendar events can be subsequently displayed to a user of mobile computing device 102. In some embodiments, the mobile computing device 102 can compare the dates and times of the generated calendar events with existing events already stored in the calendar database 112, and alert the user of potential scheduling conflicts.

In some embodiments, in block 210, the mobile computing device 102 edits, revises, amends, or otherwise changes one or more of the generated calendar events. To do so, the mobile computing device 102 can receive user input data indicative of the change(s) requested by the user. For example, in some embodiments, the mobile computing device 102 can receive user input data indicative of a user's request to change, among other data, the event title, event date, event duration, event location, event description, and event notes. In such embodiments, the mobile computing device 102 can revise and/or change the corresponding calendar event accordingly. It should be appreciated that the user input data for each event or set of events can include a list of invitees (e.g., other users) to be informed of the calendar event(s). Invitees may be identified by user name/identifier, device name/identifier, calendar name/identifier, email address, or any other means of identification.

In block 212, the mobile computing device 102 stores the one or more calendar events in the calendar database 112. In some embodiments, a calendar application (“calendar app”) executed by the mobile computing device 102 can access the calendar database 112 and visually display the one or more calendar events to the user. Additionally, the mobile computing device 102 can transmit and/or synchronize the calendar event(s) with the remote calendar server 120, in some embodiments. This transmission can include the propagation of shared events to a list of invitees as specified by the user. Additionally or alternatively, in some embodiments, the mobile computing device 102 can generate an calendar event that is transmitted to a social media site as a social media event. It should be appreciated that the calendar event can be transmitted to any other type of electronic resource and shared with any number of users.

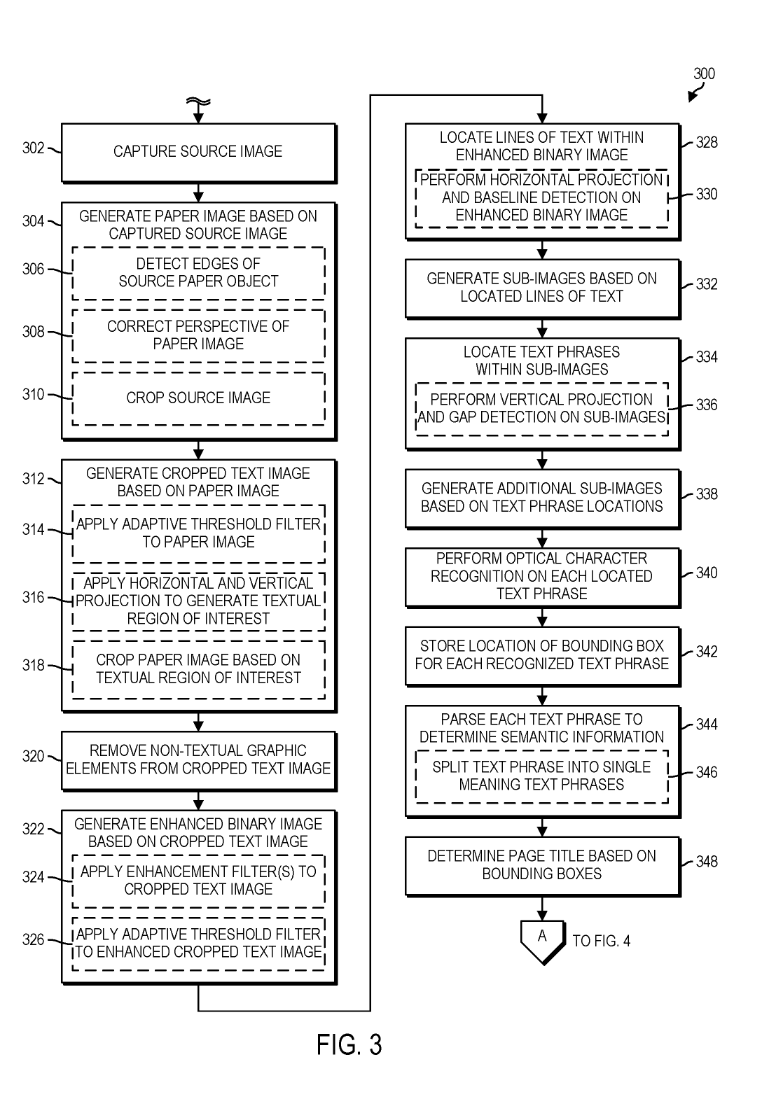

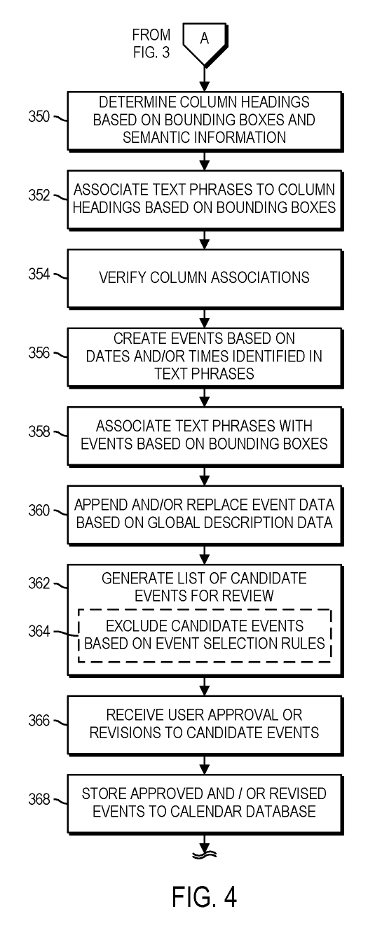

Referring now to FIGS. 3 and 4, an embodiment of another method 300 that may be executed by the mobile computing device 102 for digitizing calendars begins with block 302 in which the mobile computing device 102 captures a source image (e.g., a first image) of a paper or physical version of a calendar, agenda, schedule, or any other type of time management data. To do so, in some embodiments, the mobile computing device 102 can capture the source image via the one or more cameras 116. Additionally or alternatively, the source image of the paper or physical version of the calendar or agenda can be captured by a device other than the mobile computing device 102. In such embodiments, the mobile computing device 102 can receive the source image from the device that captured the image or an intermediary computing device (e.g. a cloud server, another mobile computing device, etc.). In other embodiments, the mobile computing device 102 can retrieve the source image from a local repository (e.g., the data storage 110) of the mobile computing device 102.

In block 304, the mobile computing device 102 generates a paper image (e.g., a second image) based on the captured source image. The paper image can be embodied as an image containing only the region of the source image within which the paper or physical version of the calendar (e.g., the source paper object) is represented. In some embodiments, to generate the paper image, the mobile computing device 102, in block 306, detects the edges of the source paper object. Additionally, in block 308, the mobile computing device 102 can correct the perspective of the paper image. For example, in embodiments in which the paper image is skewed or rotated, the mobile computing device 102 can straighten and/or rotate the paper image to correct the perspective. In some embodiments, in block 310, the mobile computing device 102 crops the source image to generate the paper image.

In block 312, the mobile computing device 102 generates a cropped text image (e.g., a third image) based on the paper image. The cropped text image can be embodied as an image containing only the region of the paper image within which text or other characters are represented. For example, the cropped text image can be embodied as an image that excludes whitespace or other non-character objects or artifacts. In some embodiments, to generate the cropped text image, the mobile computing device 102, in block 314, applies an adaptive threshold filter to the paper image to form a binary image (e.g., a fourth image). This and similar techniques help eliminate differences in lighting across the source image, which results in a cleaner binary image of text on paper. The binary image can be embodied as an image containing only black and white pixels. It should be appreciated that the mobile computing device 102 can generate an image containing any two other colors. In such embodiments, the cropped text image is embodied as the binary image (e.g., the fourth image). Additionally, in block 316, the mobile computing device 102 applies horizontal and vertical projection on the binary image to generate, or otherwise identify, a textual region of interest within the paper image. In block 318, the mobile computing device 102 can crop the paper image based on the generated and/or identified textual region of interest. In some embodiments, the horizontal and vertical projection data derived in block 316 can be analyzed to detect whether the text on the paper appears in portrait (e.g., horizontal lines of text) or landscape (e.g., vertical lines of text) orientation. In such embodiments, all images containing landscape oriented text (e.g., a schedule or agenda with lines of text running vertically within the image) can be rotated to a common portrait orientation such that the text now runs horizontally.

In block 320, the mobile computing device 102 detects and removes logos, icons, pictures, grid lines, and other non-textual graphics in the cropped text image via various image processing techniques. In some embodiments, the mobile computing device 102 can be configured to enable a user to define and/or modify the selection of automatically-suggested non-textual graphic elements. Regardless of how the mobile computing device 102 determines or identifies the non-textual graphics, the mobile computing device 102 erases or paints over the non-textual graphics to form a cropped non-graphical text image (e.g., a fifth image).

In block 322, the mobile computing device 102 generates an enhanced binary image (e.g., a sixth image) based on, or as a function of, the cropped non-graphical text image. To do so, in some embodiments, the mobile computing device 102, in block 324, applies one or more image sharpening, noise reducing, and/or edge-enhancing filters to improve the clarity of text in the cropped non-graphical text image. In block 326, the mobile computing device 102 applies an adaptive threshold filter to the enhanced cropped text image. The enhanced binary image can be embodied as an image containing only black and white pixels. It should be appreciated that the mobile computing device 102 can generate an image containing any two other colors.

In block 328, the mobile computing device 102 locates lines of text within the enhanced binary image. To do so, in block 330, the mobile computing device 102 can perform horizontal projection and baseline detection on the enhanced binary image to locate the lines of text. It should be appreciated that, in other embodiments, the mobile computing device 102 can perform any other suitable technique for locating lines of text within the enhanced binary image.

In block 332, the mobile computing device 102 generates multiple sub-images based on the lines of text located within the enhanced binary image. In some embodiments, the mobile computing device 102 generates a horizontal sub-image for each located line of text. Each horizontal sub-image may extend the width of the enhanced binary image. It should be appreciated that, in other embodiments, the mobile computing device 102 can generate a horizontal sub-image for more than one located line of text (e.g., two or more lines). Additionally, the sub-images generated by the mobile computing device 102 may be of different shapes and sizes, in some embodiments.

In block 334, the mobile computing device 102 locates text phrases within the generated sub-images. To do so, in block 336, the mobile computing device 102 can perform vertical projection and gap detection on the generated sub-images to determine where each text phrase begins and ends. It should be appreciated that, in other embodiments, the mobile computing device 102 can perform any other suitable technique for locating text phrases within the generated sub-images.

In block 338, the mobile computing device 102 generates additional sub-images based on the locations of the text phrases found within the original sub-images. In some embodiments, the mobile computing device 102 generates a vertical sub-image for each located text phrase. That is, for each text phrase located within a particular horizontal sub-image, the mobile computing device 102 can vertically divide the horizontal sub-image into additional sub-images. Each additional sub-image can contain a single text phrase.

In block 340, the mobile computing device 102 performs optical character recognition (OCR) on each located text phrase. It should be appreciated that any number of different OCR techniques may be performed on the text phrases including the recognition of printed, typed, handwritten, and/or any other form of text. In some embodiments, as part of OCR processing, the mobile computing device 102 can generate a bounding box relative to the paper image (e.g., the second image) for each text phrase processed. In such embodiments, in block 342, the mobile computing device 102 stores the location of the bounding box for each recognized text phrase. The bounding box locations can be stored in the data storage 110 of the mobile computing device 102.

In block 344, the mobile computing device 102 parses each recognized text phrase to determine semantic information or a meaning associated therewith. In some embodiments, the semantic information includes a date, time, duration, location, title, meeting notes, description, or any other type of information for determining a meaning of the text phrases. The semantic information and/or meaning associated with each text phrase can be determined via keyword matching and/or any other logic suitable for determining semantic information and/or the meaning of a text phrase. For example, in some embodiments, the mobile computing device 102 can parse each text phrase and determine whether certain reference keywords (e.g., “date,” “time,” “location,” “duration,” “notes,” “description,” “Monday,” “Tuesday,” “January,” “February,” etc.) are included therein. In some embodiments, in block 346, the mobile computing device 102 further splits a text phrase into multiple text phrases such that each text phrase only has one meaning. For example, in embodiments in which a particular sub-image includes a text phrase with multiple meanings, the mobile computing device 102 can split the original text phrase into separate text phrases based on their particular meaning. The bounding box of the original text phrase may be similarly split to encompass the newly separated text phrases.

In block 348, the mobile computing device 102 determines the page title (e.g., the calendar or agenda title) based on the bounding boxes. For example, based on the locations of the bounding boxes, the mobile computing device 102 can determine the page title. In some embodiments, the determined page title can be used by the mobile computing device 102 as an event title for subsequently generated calendar events.

In block 350, in some embodiments, the mobile computing device 102 determines column headings based on the bounding boxes and the determined semantic information. For example, the mobile computing device 102 can determine that, based on the bounding boxes and the determined semantic information, the column headings of the paper or physical version of the calendar, agenda, schedule, or other time management data are “time,” “date,” “description,” and “notes.” It should be appreciated that any other column headings can be determined by the mobile computing device 102, in other embodiments.

In block 352, the mobile computing device 102 associates each recognized text phrase with one of the determined column headings. In some embodiments, the mobile computing device 102 associates each text phrase with a column heading based at least in part on, or otherwise as a function of, the bounding boxes. In some embodiments, in block 354, the mobile computing device 102 verifies the column associations. To do so, in some embodiments, the mobile computing device 102 can analyze each text phrase and adjust the confidence level of previously assigned semantic information. The text phrase confidence level can be compared to a column heading confidence level. In some embodiments, the text phrase confidence level can be updated and/or revised (e.g., reinforced, diminished, etc.) based on the comparison. Additionally or alternatively, the column heading confidence level can be updated and/or revised (e.g., reinforced, diminished, etc.) based on the comparison.

In block 356, the mobile computing device 102 generates or creates one or more candidate calendar events based on the recognized text phrases (and/or the determined semantic information). For example, in some embodiments, the mobile computing device 102 creates the candidate calendar event(s) based at least in part on one or more dates and/or times recognized or identified in the text phrases. In some embodiments, the mobile computing device 102 generates multiple candidate calendar events based on the recognized text phrases.

In block 358, the mobile computing device 102 associates the recognized text phrases (or the remaining recognized text phrases and/or the determined semantic information) with the generated candidate calendar event(s) based on the bounding boxes. For example, text phrases having bounding boxes located in the same row may be associated with the same candidate calendar event for schedules or agendas utilizing a row-based format. For grid-based calendars (e.g., a traditional monthly calendar with a grid of 7 days per week horizontally and 4 to 6 weeks vertically), text phrases can be associated with events contained within the same grid cell (e.g., on a specific day within a traditional monthly calendar). It should be appreciated that the remaining recognized text phrases may be associated with the appropriate calendar event according to any other process or technique.

In block 360, the mobile computing device 102 appends and/or replaces event data (e.g., event name, description, start time, end time, location, notes, etc.) corresponding to one or more calendar events based on global description data. The global description data includes global event settings or preferences of the user as well as predicted values. For example, in some embodiments, the global event data may include a default location or event duration. In some embodiments, the mobile computing device 102 may predict values for global description data based on the bounding boxes, semantics, and values of recognized text phrases, such as utilizing the page title derived in block 348 as event names. In such embodiments, the mobile computing device 102 can append and/or replace the corresponding event data with the global description data. It should be appreciated that the global description data can include a list of invitees (e.g., other users) to be informed of the calendar event(s). Invitees may be identified by user name/identifier, device name/identifier, calendar name/identifier, email address, or any other means of identification. Additionally, in some embodiments where the mobile computing device 102 supports multiple named calendars containing distinct events (e.g., “Home,” “Work,” “Spouse,” “Son,” “Daughter,” etc.), the global description data can include a list of named calendars to be checked for potential scheduling conflicts with candidate calendar events.

In block 362, the mobile computing device 102 generates a list of the candidate calendar events for review by the user. To facilitate the user's review, the mobile computing device 102 can display the list to the user via a display. In embodiments which check for scheduling conflicts, this displayed list can indicate which events are double booked. In some embodiments, in block 364, the mobile computing device 102 excludes (e.g., removes, deletes, etc.) one or more of the candidate calendar events from the list. For example, the mobile computing device 102 can exclude one or more of the candidate calendar events from the list based on one or more event selection rules, which may be configured by the user. The selection rules can specify the types of events the user is interested in (e.g., home games, team-specific events, weekday-specific morning classes, instructor name, future events, etc.). For example, one or more selection rules can specify that mandatory attendance meetings should be included in the list of candidate calendar events, and thus optional attendance events should be excluded.

In block 366, the mobile computing device 102 receives the user's approval and/or revisions to one or more of the candidate calendar events included in the list. For example, in some embodiments, the mobile computing device 102 can receive the user's approval of all of the candidate calendar events included in the list. In other embodiments, the mobile computing device 102 receives the user's revisions to the event data corresponding to one or more of the candidate calendar events. Such revisions can modify any value of an event's data (e.g., event name, description, date, start time, end time, location, notes, etc.) as well as the list of invitees for a shareable event.

In block 368, the mobile computing device 102 stores the approved and/or revised calendar events in the calendar database 112. In some embodiments, a calendar application (“calendar app”) executed by the mobile computing device 102 can access the calendar database 112 and visually display the one or more calendar events to the user. Additionally, the mobile computing device 102 can transmit and/or synchronize the calendar event(s) with the remote calendar server 120, in some embodiments, as well as propagate shared events to their respective list of invitees.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. A method for digitizing a physical version of a calendar, the method comprising:
receiving, by a mobile computing device, a source image representative of a physical version of a calendar;
identifying, by the mobile computing device, a textual region of interest within the source image;
cropping, by the mobile computing device, the source image to the textual region of interest to generate a cropped source image;
analyzing, by the mobile computing device, the cropped source image to identify time management data included therein;
generating, by the mobile computing device, a calendar event based at least in part on the identified time management data; and
storing, by the mobile computing device, the generated calendar event in a local calendar database of the mobile computing device.

2. The method of claim 1, wherein receiving the source image comprises capturing an image representative of the physical version of the calendar with a camera of the mobile computing device.

3. The method of claim 1, wherein receiving the source image comprises receiving the source image from a different computing device.

4. The method of claim 1, wherein identifying the textual region of interest within the source image comprises determining one or more areas within the source image that include text.

5. The method of claim 1, further comprising:
receiving, by the mobile computing device, selection data indicative of a selected textual region of interest within the source image; and
wherein identifying the textual region of interest comprises identifying the textual region of interest within the source image based at least in part on the received selection data.

6. The method of claim 1, wherein analyzing the cropped source image to identify the time management data included therein comprises performing optical character recognition on the cropped source image to identify one or more of calendar event data, a text phrase, and individual characters.

7. The method of claim 1, wherein analyzing the cropped source image to identify the time management data included therein comprises recognizing one or more text phrases within the cropped source image indicative of an upcoming event; and
wherein generating the calendar event comprises generating the calendar event based at least in part on the one or more recognized text phrases indicative of the upcoming event.

8. The method of claim 7, wherein the one or more recognized text phrases indicative of the upcoming event comprise at least one of a date value, a time value, a duration value, a title, a description, or a note corresponding to the upcoming event.

9. The method of claim 1, wherein analyzing the cropped source image comprises analyzing the cropped source image to identify the time management data included therein based at least in part on a calendar type-specific template corresponding to a type of the calendar, wherein the calendar type-specific template specifies one or more calendar type-specific settings for recognizing the time management data included within the calendar.

10. The method of claim 1, further comprising:
comparing, by the mobile computing device, the generated calendar event to one or more existing calendar events stored in the local calendar database;
determining, by the mobile computing device and based on the comparison, whether a scheduling conflict exists between the generated calendar event and the one or more existing calendar events; and
generating, by the mobile computing device, an alert in response to determining that a scheduling conflict exists.

11. The method of claim 1, wherein generating a calendar event comprises generating a reoccurring calendar event based at least in part on the identified time management data.

12. A method for digitizing a physical version of a calendar, the method comprising:
receiving, by a mobile computing device, a source image representative of a physical version of a calendar;
cropping, by the mobile computing device, the source image to generate a paper image, the paper image including only a region of the source image within which the physical version of the calendar is represented;
generating, by the mobile computing device, a cropped text image based on the paper image, the cropped text image including only a region of the paper image within which character objects are presented;
removing, by the mobile computing device, non-textual objects presented within the cropped text image to generate a cropped non-graphical text image;
generating, by the mobile computing device, an enhanced binary image based on the cropped non-graphical text image, the enhanced binary image is an image including pixels of only two colors;
generating, by the mobile computing device, a plurality of horizontal sub-images based on lines of text located within the enhanced binary image, each horizontal sub-image of the plurality of horizontal sub-images corresponds to a different line of text located within the enhanced binary image;
locating, by the mobile computing device, one or more text phrases within each of the plurality of horizontal sub-images;
generating, by the mobile computing device, a plurality of bounding boxes relative to the paper image, each of the generated bounding boxes corresponds to a different one of the one or more text phrases located within the plurality of horizontal sub-images;
determining, by the mobile computing device, semantic information for each text phrase located within the plurality of horizontal sub-images;
generating, by the mobile computing device, a candidate calendar event based at least in part on the determined semantic information for each text phrase located within the plurality of horizontal sub-images;
displaying, by the mobile computing device, the candidate calendar event for user approval; and
storing, by the mobile computing device, the candidate calendar event in a local calendar database of the mobile computing device in response to receiving user approval data.

13. The method of claim 12, wherein receiving the source image comprises one of (i) capturing an image representative of the physical version of the calendar with a camera of the mobile computing device or (ii) receiving the source image from a different computing device.

14. The method of claim 12, further comprising:
storing, by the mobile computing device, a location of each bounding box of the plurality of bounding boxes generated relative to the paper image for each text phrase;
determining, by the mobile computing device, a page title of the calendar based on the plurality of bounding boxes relative to the paper image;
determining, by the mobile computing device, a plurality of column headings based at least in part on the plurality of bounding boxes and the determined semantic information; and
associating, by the mobile computing device, each text phrase located within the plurality of horizontal sub-images with a column heading of the plurality of column headings based at least in part on the plurality of bounding boxes.

15. The method of claim 12, further comprising replacing, by the mobile computing device, calendar event data that corresponds to the candidate calendar event with global description data, the global description data comprises reference event settings and user preferences.

16. The method of claim 15, wherein the calendar event data comprises at least one of a date value, a time value, a duration value, a title, a description, or a note corresponding to the candidate calendar event.

17. The method of claim 12, further comprising appending, by the mobile computing device, global description data to calendar event data that corresponds to the candidate calendar event, the global description data comprises reference event settings and user preferences.

18. The method of claim 12, further comprising generating, by the mobile computing device, a plurality of vertical sub-images from a horizontal sub-image of the plurality of horizontal sub-images, each vertical sub-image of the plurality of vertical sub-images corresponds to a different text phrase located within the horizontal sub-image.

19. The method of claim 12, wherein cropping the source image to generate the paper image comprises detecting one or more edges of the physical version of the calendar represented in the source image.

20. The method of claim 12, further comprising correcting, by the mobile computing device, a perspective of the paper image.
